(19) United States
(12) Patent Application Publication
(10) Pub. No.: US 2009/0033284 A1
(43) Pub. Date: Feb. 5, 2009

(54) Charging device with battery capacity analysis function

(75) Inventor: I-Chang Chang, Sijhih City (TW)

Correspondence Address: Troxell Law Office Pllc;Suite 1404, 5205 Leesburg Pike, Falls Church, VA, 22041, US

(73) Assignee: Iwei Technology Co., Ltd.

(21) Appl. No.: 11/882,080

(22) Filed: Jul. 30, 2007

(51) Int. Cl. H02J 7/00

(52) U.S. Cl. 320/131

(57) ABSTRACT

The present invention provides a charging device with battery capacity analysis function, wherein a charging device includes a control unit, a computing unit, a display unit, a charging unit and a discharging unit. When the charging unit is connected to and charging a battery, the control unit determines whether the power of the battery is fully charged or not, and after the battery is fully charged, then the charging unit stops charging, and at the same time the discharging unit implements discharging of the battery. Moreover, the control unit controls stopping of electric discharge after the battery power is exhausted, which enables the computing unit to determine and calculate actual effective capacity of the battery, and enables the display unit to display the calculated capacity data, after which fully charging of the battery continues, thereby enabling the charging device to achieve battery capacity analysis and charging effectiveness.

### BACKGROUND OF THE INVENTION

(a) Field of the Invention

The art of the present invention provides a charging device with battery capacity analysis function, which, when a charging device is connected to and charging a battery, uses a built-in control unit of the charging device to determine whether a battery connected to the charging device is fully charged or not. After the battery is fully charged, a charging unit stops charging the battery, whereupon the battery discharges a constant current by means of a discharging unit, and the control unit controls stopping of discharge after the power of the battery is exhausted.

(b) Description of the Prior Art

Referring to FIG. 1 and FIG. 2, which show a general charging equipment A as seen in the market, function of which is to charge a battery A1 connected thereto. When a battery charger A2 is connected to and charging the battery A1, electric circuits of the battery charger A2 are unable to discern whether or not the battery A1 is damaged, malfunctioning, aging or is unable to store power. Hence, when it is required to determine the condition of the battery A1, a discharger A3 must be additionally connected to the battery charger A2, which simultaneously calculates total power consumption of the battery A1 being discharged, thereby enabling discerning whether functionality of the battery A1 is normal or not. However, not only are the additionally connected battery charger A2 and discharger A3 relatively inconvenient to use, but also increase concern over space occupied and cost. Hence, the inventor of the present invention proposes to resolve and surmount existent technical difficulties to eliminate the aforementioned shortcomings of prior art.

### SUMMARY OF THE INVENTION

The art of the present invention provides a charging device with battery capacity analysis function, which, when a charging device is connected to and charging a battery, uses a built-in control unit of the charging device to determine whether a battery connected to the charging device is fully charged or not. After the battery is fully charged, a charging unit stops charging the battery, whereupon the battery discharges a constant current by means of a discharging unit, and the control unit controls stopping of discharge after the power of the battery is exhausted, which enables a computing unit to calculate actual effective capacity of the battery. After a display unit displays the calculated capacity data, the charging unit at the same time continues to fully charge the battery, thereby enabling the charging device to achieve battery capacity analysis and charging effectiveness.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 shows a block diagram of prior art.

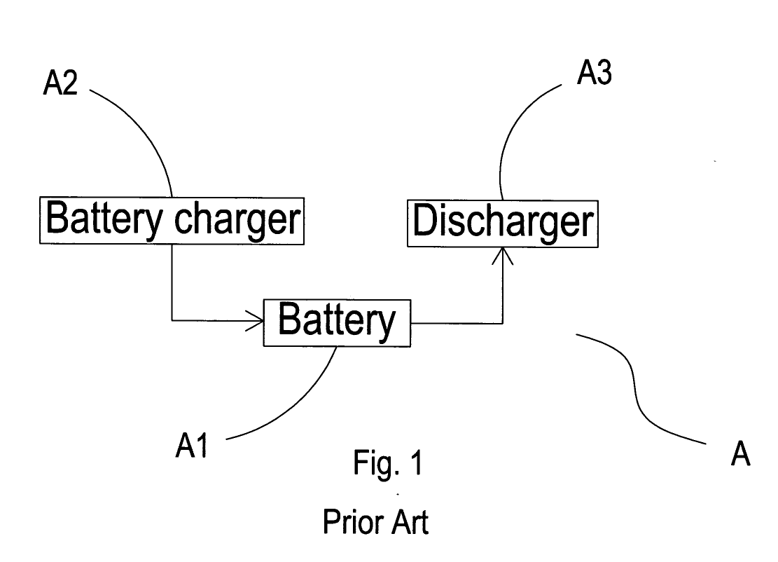

FIG. 2 shows an elevational view of prior art.

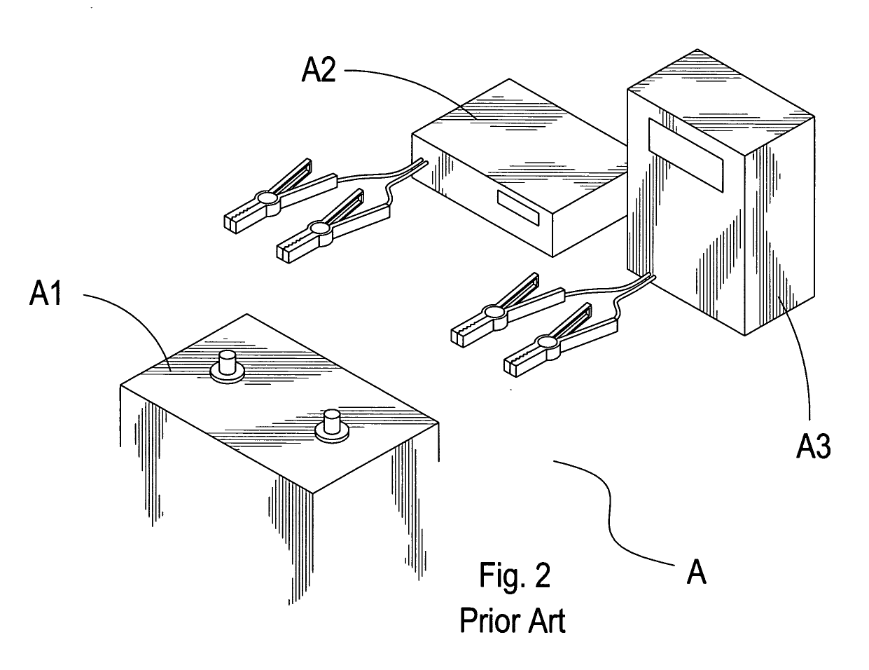

FIG. 3 shows a first block diagram of the present invention.

FIG. 4 shows an elevational view of the present invention.

FIG. 5 shows a second block diagram of the present invention.

FIG. 6 shows a circuit diagram of the present invention.

FIG. 7 shows a circuit block diagram of the present invention.

### DETAILED DESCRIPTION OF THE PREFERRED EMBODIMENTS

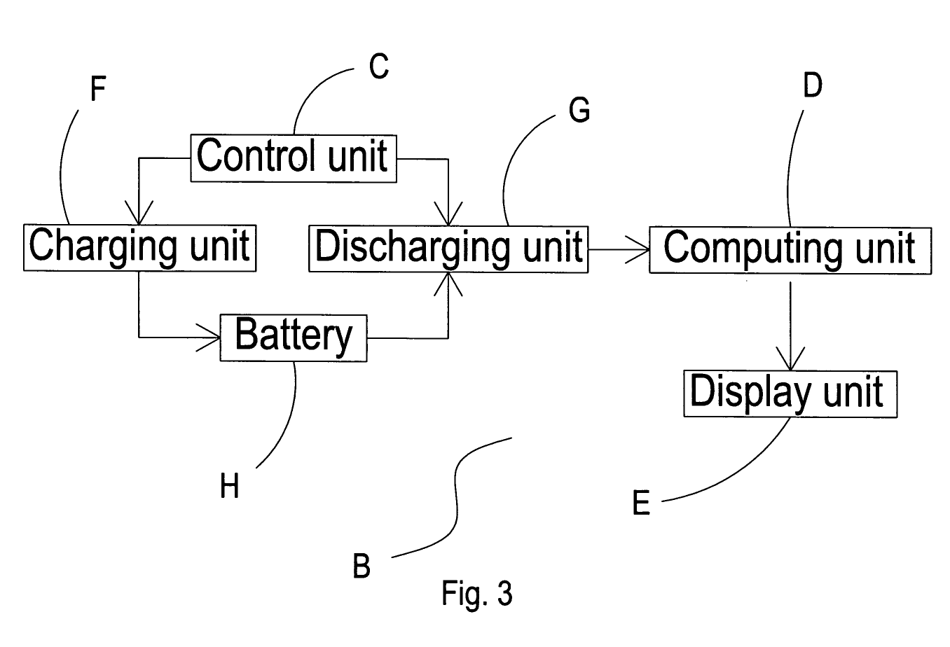

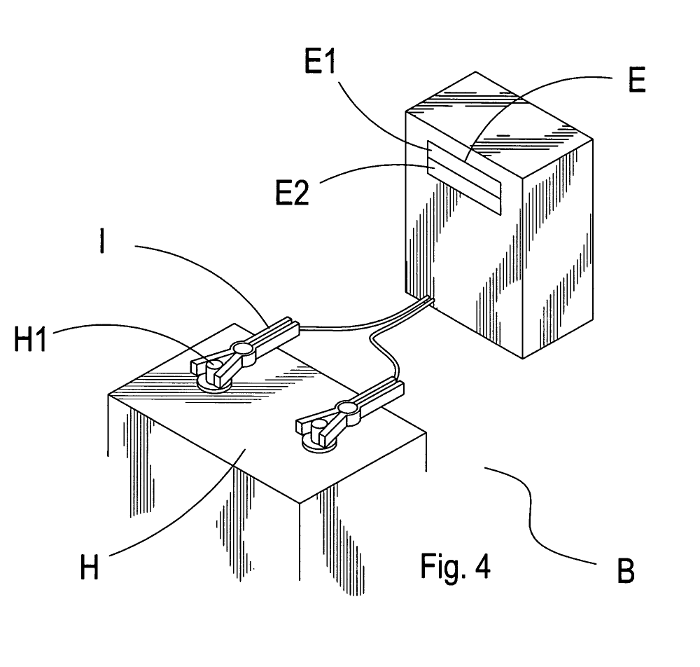

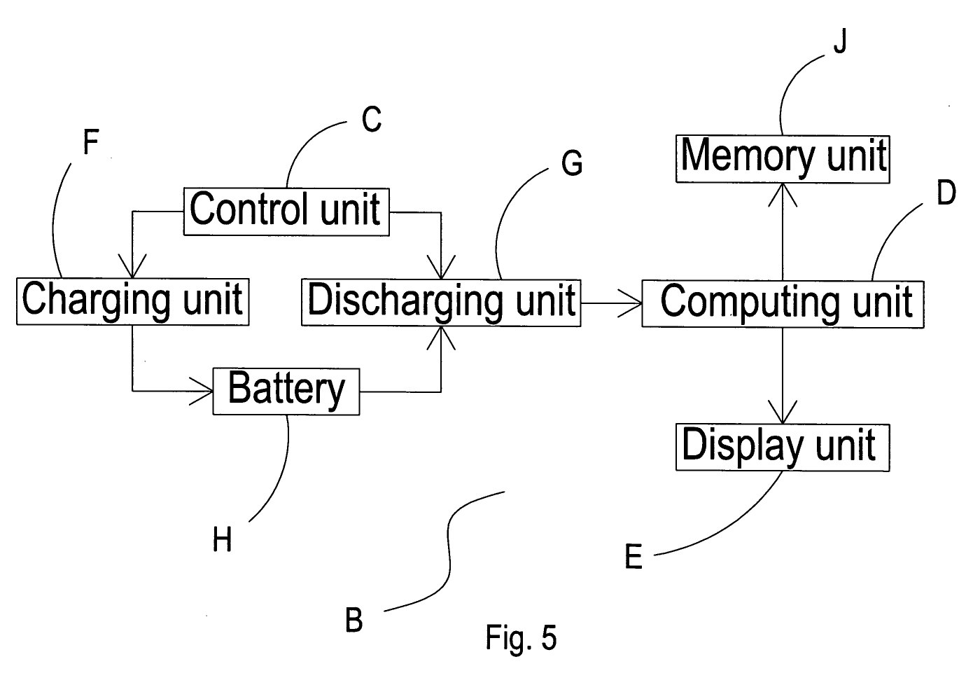

Referring to FIG. 3, FIG. 4 and FIG. 5, the present invention provides a charging device with battery capacity analysis function, and more particularly a charging device B provided with a built-in battery capacity analysis function, wherein the charging device B comprises a control unit C, a computing unit D, a display unit E, a charging unit F and a discharging unit G. The present invention is characterized in that; the charging device B comprises the control unit C built therein, and the control unit C is in correspondence with the computing unit D. Moreover, the control unit C is in relative correspondence with the display unit E of the charging device B.

The charging device B comprises the charging unit F and the discharging unit G, and the charging unit F and the discharging unit G are in relative correspondence with a battery H. Moreover, the battery H is in relative correspondence with the computing unit D and the display unit E of the control unit C.

When the charging unit F is connected to and charging the battery H, then the control unit C determines whether the battery H is fully charged or not. Moreover, after the battery H is fully charged, then the discharging unit G carries out discharging of the battery H, and the control unit C at the same time determines when the power of the battery H is exhausted, whereupon electric discharge is stopped, which enables the computing unit D to calculate total power consumption of the battery H.

The control unit C and the computing unit D are able to determine and calculate total power consumed between the battery H and the discharging unit G, at the same time the calculated total power data can be displayed by the display unit E, after which the battery H connected to the charging device B is again charged, thereby enabling the charging device B to achieve the objectives of battery capacity analysis and charging.

An embodiment of the present invention provides the charging device with battery capacity analysis function, as depicted in FIG. 3, FIG. 4 and FIG. 5, wherein the charging device B comprises the control unit C built therein, and the control unit C is in correspondence with the computing unit D. Moreover, the control unit C is in relative correspondence with the display unit E of the charging device B. The charging device B comprises the charging unit F and the discharging unit G, and the charging unit F and the discharging unit G are in relative correspondence with the battery H. Moreover, the battery H is in relative correspondence with the computing unit D and the display unit E of the control unit C.

When the charging unit F is connected to and charging the battery H, then the control unit C determines whether the power of the battery H is fully charged or not. Moreover, after the battery H is fully charged, then the discharging unit G carries out discharging of the battery H and the control unit C at the same time determines when the power of the battery H is exhausted, whereupon electric discharge is stopped. Furthermore, the computing unit D calculates total power consumption of the battery H, which enables the calculated total power data to be displayed by the display unit E.

The charging device B comprises power source conducting units 1, which are in relative correspondence with conducting terminals H1 of the battery H, thereby enabling the charging device B provided with a battery capacity analysis function to connect to the battery H and achieve the objectives of providing battery capacity analysis and a charging function. Moreover, the charging device B further comprises a memory unit J, which implements functionality to memorize capacity after charging and discharging of the battery H.

Furthermore, the display unit E of the charging device B can be configured with an LCD (liquid crystal display) display device E1, an LED (light-emitting diode) display device E2 and related devices provided with the ability to display total power data of a battery.

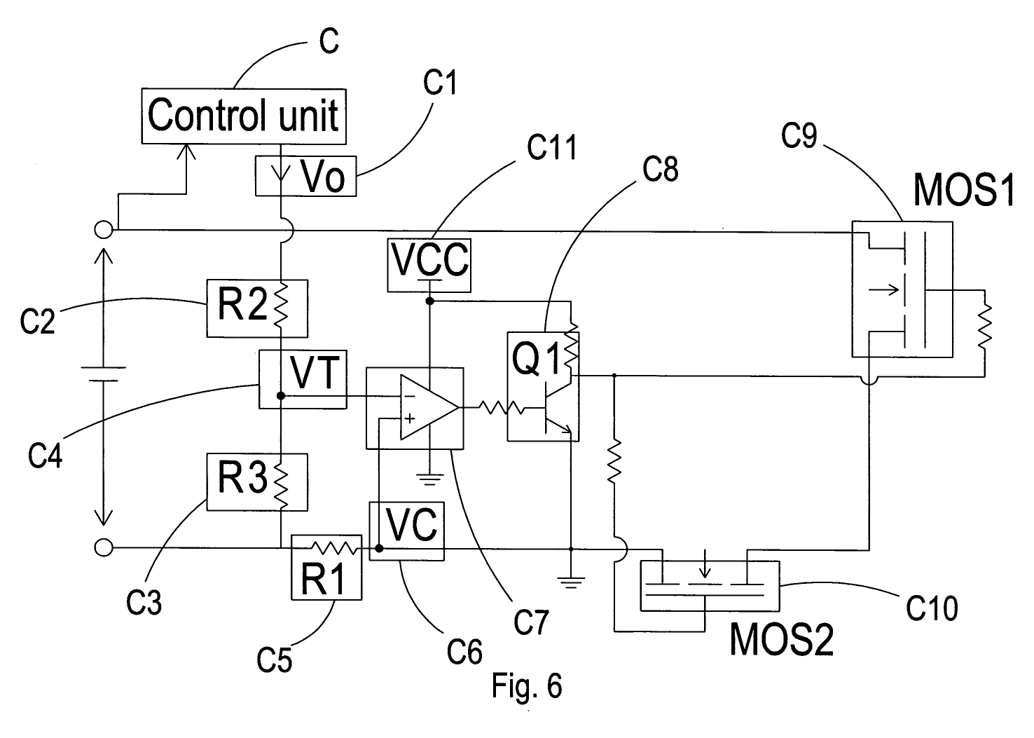

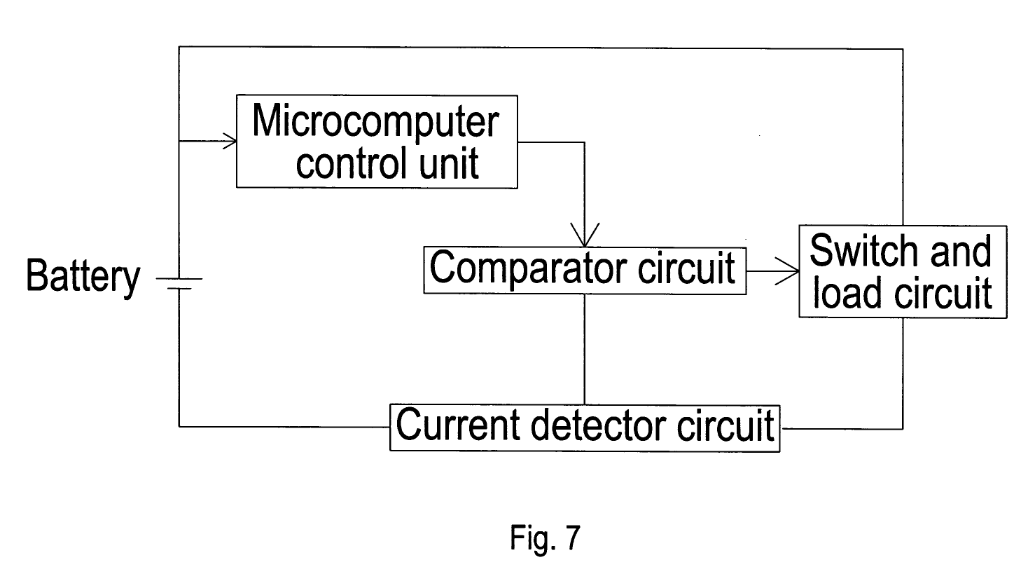

Referring to FIG. 5, FIG. 6 and FIG. 7, if output Vo from a pin (C1) of the control unit C is 1V, then the discharging current is 1 A, and after voltage dividing of the electric potential Vo (C1) by passing through R₂ (C2), R₃ (C3), then V_{T} (C4)=10 mV. Suppose at this time the electric current flowing through R₁ (C5) is 0.5 A, then voltage V_{C} (C6)=5 mV, and after comparing the V_{T} (C4) with the V_{C} (C6) through OP (C7), then the output is Lₒ, which causes Q1 (C8) to assume an OFF state. The Q1 (C8) assuming an OFF state simultaneously causes MOS (Metal Oxide Semiconductor) 1 (C9) and MOS2 (C10) to be simultaneously ON, thereby causing discharging current to rapidly rise. When the electric current rises to 1.1 A, then V_{CC} (C11) becomes 11 mV. Because the OP (C7) carries out continuous uninterrupted comparison amplification of the magnitudes of the voltages V_{C} (C6) and the V_{T} (C4), thus, output of the OP (C7) becomes Hᵢ, which causes the Q1 (C8) to assume an ON state, and causes the MOS1 (C9) and MOS2 (C10) to simultaneously be in an OFF state, whereupon the discharging current rapidly drops, and when the electric current drops to 0.9 A, then the V_{C} (C6)=9 mV, which further causes output of the OP (C7) to be Lₒ, and the Q1 (C8) assumes an OFF state, and the MOS1 (C9) and MOS2 (C10) assume an ON state, thereby causing the electric current to rise. Because of the comparison carried out by the OP (C7), thus, the Q1 (C8) is caused to be in continuous ON, OFF states, which causes the MOS1 (C9) and MOS2 (C10) to also be in continuous ON, OFF states. Accordingly, the discharging current is caused to form a fixed constant electric current, thus the control unit C is set, so that when the battery H has been discharged to a certain magnitude of voltage, then discharge is stopped and discharge time is simultaneously recorded, and multiplying the discharge time by the discharging current gives actual effective capacity of the battery H.

To further emphasize the advancement and practicability of the present invention, the advantages of the present invention are listed as follows:

1. Use of the battery capacity analysis unit, the control unit and the computing unit built in the charging device B enables determining and accurately calculating capacity of a battery.

2. Use of the built-in battery capacity analysis unit enables determining and analyzing the condition and actual effective capacity of a battery, thereby achieving the objectives of providing charging and discharging measuring functionality.

3. The charging device B with the built-in battery capacity analysis unit is more convenient to use, and does not increase concern over space occupied by the device and cost.

4. Provided with industrial competitiveness.

5. Provided with commercial use value.

6. Provided with originality.

In conclusion, the present invention clearly complies with essential elements as required for a new patent application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A charging device with battery capacity analysis function, wherein a charging device comprises a control unit, a computing unit, a display unit, a charging unit and a discharging unit; when the charging unit is connected to and charging a battery, the control unit determines whether the battery is fully charged or not; after the battery is fully charged, then charging is stopped and the discharging unit carries out discharging of the battery, and the control unit controls stopping of electric discharge after the power of the battery is exhausted, which enables the computing unit to calculate actual effective capacity of the battery, whereupon the calculated actual effective capacity data is displayed by the display unit, thereby enabling the charging device to achieve battery capacity analysis and charging effectiveness.

2. The charging device with battery capacity analysis function according to claim 1, wherein the display unit is configured with an LCD (liquid crystal display) display device, an LED (light-emitting diode) display device, digital type light-emitting diodes and related devices provided with the ability to display data.

3. The charging device with battery capacity analysis function according to claim 1, wherein the charging device further comprises a memory unit, which implements functionality to memorize capacity after charging and discharging of a battery.

4. The charging device with battery capacity analysis function according to claim 1, wherein built-in consumption load of the discharging unit is configured as loads able to consume power, including resistances, transistors, MOS (Metal Oxide Semiconductor), electronic devices, light bulbs, motors, and so on.

5. The charging device with battery capacity analysis function according to claim 1, wherein the control unit and the computing unit are integrated to form a module and integrated circuit (IC), thereby effectively increasing connections and application of related circuits.
